(19) United States
(12) Patent Application Publication
(10) Pub. No.: US 2008/0002307 A1
(43) Pub. Date: Jan. 3, 2008

(54) Thin film magnetic head and method of producing the same

(75) Inventor: Masanori Akie, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/543,169

(22) Filed: Oct. 4, 2006

(30) Foreign Application Priority Data
Jun. 30, 2006 (JP) 2006-181089

(51) Int. Cl. G11B 5/33; G11B 5/127

(52) U.S. Cl. 360/319; 29/603.01

(57) ABSTRACT

The method of producing a thin film magnetic head is capable of highly precisely flattening an upper shielding layer without badly influencing a read-element, etc. The method comprises the steps of: forming a read-element on a wafer substrate; forming a hard bias film on the both sides of the read-element; forming an upper shielding layer in a specific area, which is located on the read-element and the hard bias film and defined by outer edges of the hard bias film in a plane-direction; and removing parts of the upper shielding layer, which are outwardly projected from outer edge of the upper shielding layer in the plane-direction, by etching, wherein the upper shielding layer is used as a mask of the etching process.

### BACKGROUND OF THE INVENTION

The present invention relates to a thin film magnetic head, in which thin films, e.g., magnetic film, are layered on a wafer substrate, and a method of producing the thin film magnetic head.

These days, various types of thin film magnetic heads, each of which includes a read-element constituted by a magnetoresistance effect element, e.g., tunnel junction element (TMR), have been developed. The thin film magnetic heads are assembled in magnetic disk drive units.

A conventional method of producing a thin film magnetic head will be explained with reference to FIG. 5A-5E.

In FIG. 5A, a lower shielding layer 84 is formed on a wafer substrate 82. Note that, explanation of a structure between the wafer substrate 82 and the lower shielding layer 84 will be omitted. Further, an insulating layer 85 is formed on the both sides of the lower shielding layer 84.

Next, a tunnel junction element layer 86 is formed on the lower shielding layer 84.

Further, a resist layer 88 is formed on the tunnel junction element layer 86 by a photolithographic method. The resist layer 88 is formed and corresponded to a position 88a, at which the read-element will be formed, and areas 88b covering the tunnel junction element layer 86 except specific areas, in which a hard bias film will be formed. At that time, the resist layer 88 is constituted by two different photoresist layers: a lower sub-layer and an upper sub-layer. A thickness of the lower sub-layer is thinner than that of the upper sub-layer.

In FIG. 5B, parts of the tunnel junction element layer 86, which are exposed form the resist layer 88, are removed by ion beam etching, so that the read-element 86a is formed.

In FIG. 5C, an insulating film 90, which coats a surface of the lower shielding layer 84 and side faces of the read-element 86a, is formed. Successively, the hard bias film 92 is formed on the insulating film 90 by sputtering.

In FIG. 5D, the resist layer 88 is removed, then another resist layer 93 is formed on the read-element 86a and the hard bias film 92. The tunnel junction element layer 86 except the exposed read-element 86a is removed by etching.

Next, the resist layer 93 is removed, then, as shown in FIG. 5E, a separating layer 94 is formed on the read-element 86a, the hard bias film 92 and the lower shielding layer 84. Further, an upper shielding layer 94 is formed on the separating layer 94, then another insulating layer 98 is formed on the outer sides of the upper shielding layer 96.

Another conventional thin film magnetic head, which includes a read-element constituted by a tunnel junction element, is disclosed in Japanese Patent Gazette No. 2002-304711. A sectional view of the conventional thin film magnetic head is shown in FIG. 7. In FIG. 7, a right side face 200 is an air bearing surface of the thin film magnetic head.

The thin film magnetic head shown in FIG. 7 comprises: a lower shielding layer S1; a read-element 100, which is constituted by the tunnel junction (MTJ) element, formed on the lower shielding layer S1 with a spacer layer 162; a separating layer 104 formed on the read-element 100; and an upper shielding layer S2 formed on the separating layer 104.

However, the conventional thin film magnetic heads have following problems.

In the thin film magnetic head produced by the method shown in FIG. 5A-5E, areas of the read-element 86a and the hard bias film 92 in a plane-direction are pretty smaller than an area of the upper shielding layer 96 (see FIG. 5E). Therefore, if the separating layer 94 and the upper shielding layer 96 are formed on the read-element 86a, the hard bias film 92 and the lower shielding layer 84, the separating layer 94 and the upper shielding layer 96 are formed along step-shaped parts between the hard bias film 92 and the lower shielding layer 86; the upper shielding layer 96 cannot be formed flat.

If the upper shielding layer 96 is not flat, magnetic walls are formed on the upper shielding layer 96 and noises are included in output signals of the read-element 86a. Namely, the conventional thin film magnetic head has the problem of generating noises, which are caused by the upper shielding layer 96 having nonflat surface.

Note that, FIG. 5 is the thin film magnetic head seen from the air bearing surface side. As shown in FIG. 6, lengths of the read-element 86a and the hard bias film 92 in the height-direction are pretty shorter than that of the upper shielding layer 96. Therefore, the separating layer 94 and the upper shielding layer 96 are formed along the step-shaped parts between the read-element 86a and the lower shielding layer 84, so the separating layer 94 and the upper shielding layer 96 are not formed flat in the height-direction.

According to the Japanese patent gazette, the thin film magnetic head shown in FIG. 7 has a gap 106, which is formed between the shielding layers S1 and S2 sandwiching the read-element 100. Actually, the spacer layer 104 and the upper shielding layer S2 fill the gap 106, so that they are curved.

Note that, the upper shielding layer S2 can be formed flat by filling the gap 106 with, for example, an insulating layer, but it is difficult to highly precisely make different materials flat. Thus, the upper shielding layer S2 may be made flat by a polishing process, but the read-element 100, etc. will be badly influenced by the polishing process.

The inventors found that the problems can be solved by making outer edges of an upper shielding layer in a plane-direction coincide with those of a hard bias film. However, the outer edges will be mutually shifted, by positioning errors, in actual processing steps. If the outer edges of the upper shielding layer are outwardly projected by the errors, step-shaped parts are formed along the outer edges of the upper shielding layer. On the other hand, if the outer edges of the hard bias film are outwardly projected, magnetic characteristics of the hard bias film are made worse, and a leakage magnetic field must be weak so that magnetic domains cannot be fully controlled.

### SUMMARY OF THE INVENTION

The present invention was conceived to solve the above described problems.

An object of the present invention is to provide a method of producing a thin film magnetic head, which is capable of highly precisely flattening an upper shielding layer without badly influencing a read-element, etc.

Another object is to provide a thin film magnetic head, in which the upper shielding layer is highly precisely made flat and which is capable of reducing noises included in output signals.

To achieve the objects, the present invention has following structures.

Namely, the method of producing a thin film magnetic head of the present invention comprises the steps of: forming a read-element on a wafer substrate; forming a hard bias film on the both sides of the read-element; forming an upper shielding layer in a specific area, which is located on the read-element and the hard bias film and defined by outer edges of the hard bias film in a plane-direction; and removing parts of the upper shielding layer, which are outwardly projected from outer edge of the upper shielding layer in the plane-direction, by etching, wherein the upper shielding layer is used as a mask of the etching process.

With this method, the upper shielding layer is formed in the specific area defined by outer edges of the hard bias film. Namely, the outer edges of the hard bias film in the plane-direction are outwardly projected from those of the upper shielding layer, so that no step-shaped parts are formed between the hard bias film, the read-element and the lower shielding layer and the upper shielding layer can be highly precisely made flat. Further, the parts of the upper shielding layer, which are outwardly projected from the outer edge of the upper shielding layer in the plane-direction, are removed by etching with the upper shielding layer using as the mask of the etching process, so that the outer edges of the hard bias film and the upper shielding layer in the plane-direction can be highly precisely coincided. Therefore, even if the upper shielding layer is smaller than the hard bias film, the problems of weakening a leakage magnetic field of the hard bias film and insufficient magnetic domain control can be prevented.

In the method, a separating layer may be formed on the read-element and the hard bias film, and the upper shielding layer may be formed on the separating layer.

In the method, the step of forming the upper shielding layer may comprise the sub-steps of: forming an electric conductive layer on the separating layer; forming a resist pattern on the electric conductive layer; and forming the upper shielding layer on a part of the electric conductive layer, which is exposed from the resist pattern, by plating with using the electric conductive layer as an electric power feeding layer.

With this method, the projected parts of the hard bias film can be removed when the electric conductive layer is removed, so that a separated step for removing the projected parts can be omitted.

The method may further comprise the steps of: forming a lower shielding layer on the wafer substrate before forming the read-element; and removing parts of the lower shielding layer, which are outwardly projected from the outer edge of the upper shielding layer in the plane-direction, by etching, wherein the upper shielding layer is used as a mask of the etching process.

With this method, the outer edges of the lower shielding layer in the plane-direction can be made coincide with those of the upper shielding layer and the hard bias film.

Next, the thin film magnetic head of the present invention comprises: a read-element; a hard bias film being formed on the both sides of the read-element; and an upper shielding layer being formed on the read-element and the hard bias film, the upper shielding layer having outer edges in the plane-direction, which correspond to those of the hard bias film.

With this structure, the upper shielding layer can be highly precisely made flat, and the problems of the insufficient magnetic domain control can be prevented.

The thin film magnetic head may further comprise a lower shielding layer being located under the read-element, the lower shielding layer having outer edges in the plane-direction, which correspond to those of the upper shielding layer.

By employing the method of the present invention, the upper shielding layer can be highly precisely flattened without badly influencing the read-element, etc.

Further, in the thin film magnetic head of the present invention, the upper shielding layer can be easily flat, and noises included output signals can be reduced without forming magnetic walls.

### BRIEF DESCRIPTION OF THE DRAWINGS

Embodiments of the present invention will now be described by way of examples and with reference to the accompanying drawings, in which:

FIG. 1A-1E are partial sectional views showing steps of the method of an embodiment of the present invention;

FIG. 2F-2I are partial sectional views showing further steps of the method of the embodiment of the present invention;

FIG. 3G-3I are partial sectional views showing further steps of the method of another embodiment of the present invention;

FIG. 4 is a partial sectional view of the thin film magnetic head of an embodiment of the present invention;

FIG. 5A-5E are partial sectional views showing steps of the conventional method of producing the thin film magnetic head;

FIG. 6 is a partial sectional view of the conventional thin film magnetic head; and

FIG. 7 is a partial sectional view of another conventional thin film magnetic head.

### DETAILED DESCRIPTION OF THE EMBODIMENTS

Preferred embodiments of the present invention will now be described in detail with reference to the accompanying drawings.

The thin film magnetic head of the present embodiment is used for a magnetic disk drive unit and has a read-element constituted by a magnetoresistance effect element, e.g., tunnel junction element (TMR).

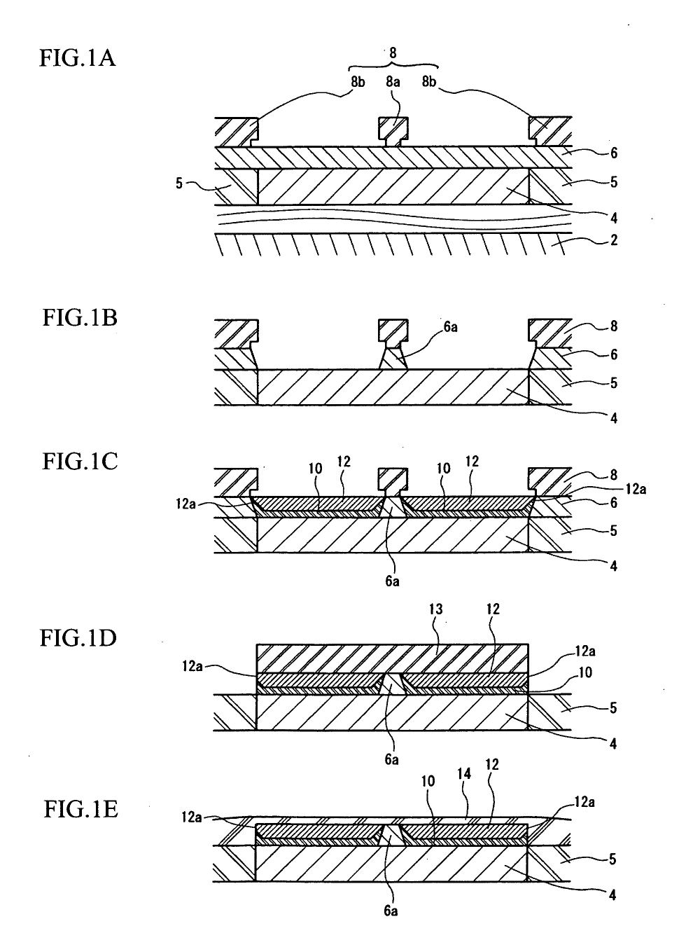

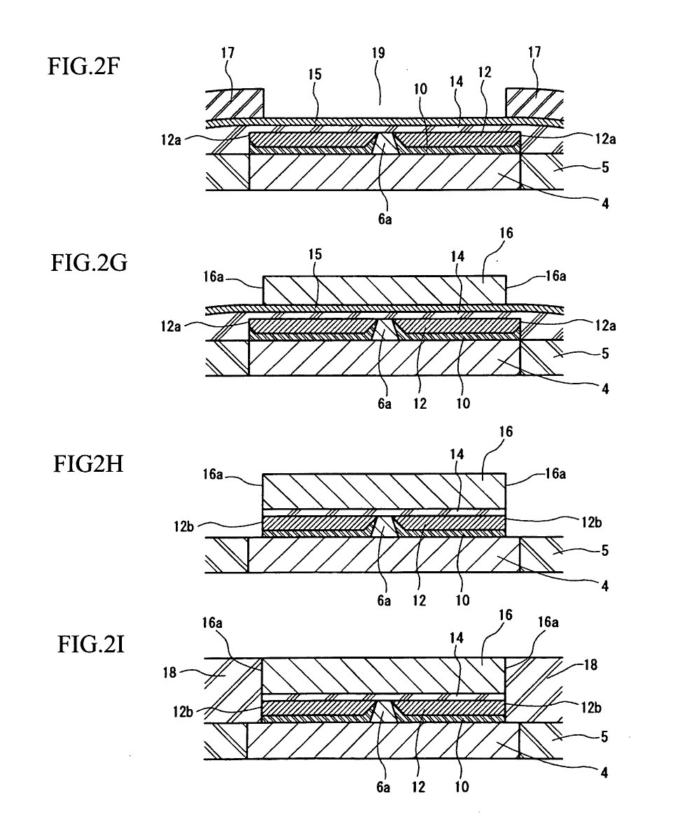

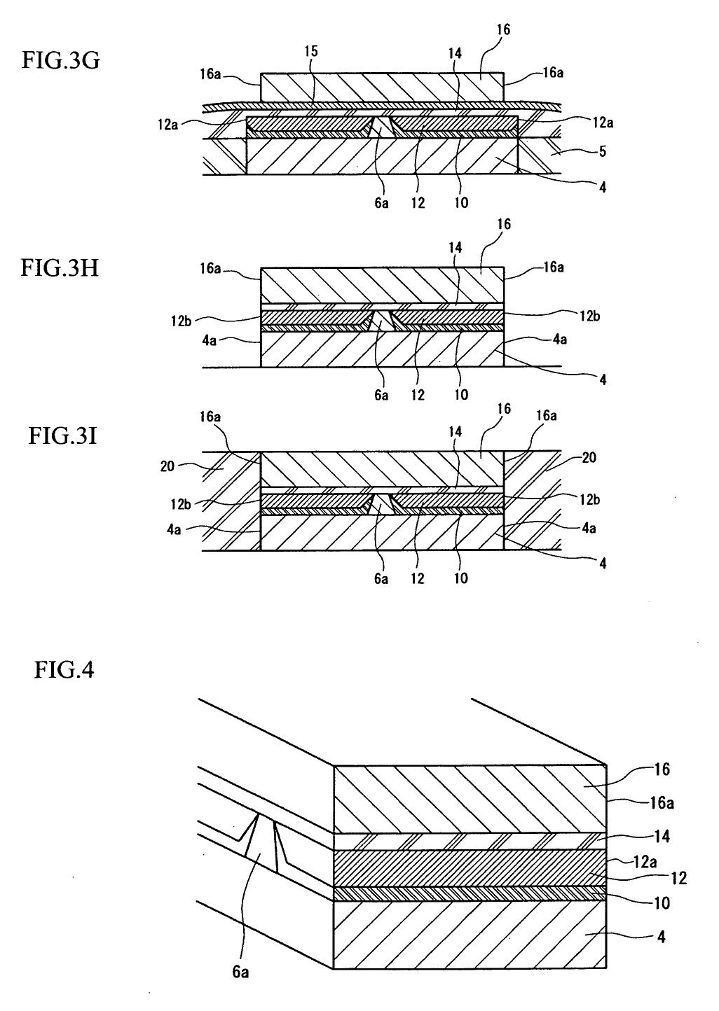

A method of producing the thin film magnetic head of the present embodiment will be explained with reference to FIG. 1A-1E, FIG. 2F-2I and FIG. 3G-3I.

In FIG. 1A, a lower shielding layer 4 is formed on a wafer substrate 2. Note that, explanation of a structure between the wafer substrate 2 and the lower shielding layer 4 will be omitted.

A separating layer 5 is formed on the outer sides of the lower shielding layer 4.

Next, a tunnel junction element layer 6 is formed on the lower shielding layer 4.

A resist layer 8 is formed on the tunnel junction element layer 6 by a photolithographic method. The resist layer 8 is formed and corresponded to a position (a resist layer 8a), at which a read-element (described later) will be formed, and areas (resist layers 8b) covering the tunnel junction element layer 6 except specific areas, in which a hard bias film (described later) will be formed. The resist layer 8 is constituted by two different photoresist layers: a lower sub-layer and an upper sub-layer. A thickness of the lower sub-layer is thinner than that of the upper sub-layer.

The resist layers 8a and 8b are formed, and a specific area, in which the hard bias film will be formed, between the resist layers 8a and 8b is made broader than an area, in which an upper shielding layer (described later) will be formed. Namely, when the resist layers 8a and 8b are formed, the specific area is defined so as to outwardly project outer edges of the hard bias film in a plane-direction from those of the upper shielding layer in the same direction.

In FIG. 1B, parts of the tunnel junction element layer 6, which are exposed form the resist layer 8, are removed by ion beam etching, so that the read-element 6a is formed. Note that, the wafer substrate 2 is omitted in FIG. 1B and the following drawings.

In FIG. 1C, an insulating film 10, which coats a surface of the lower shielding layer 4 and side faces of the read-element 6a, is formed. Then, the hard bias film 12 is formed on the insulating film 10 by sputtering. The outer edges 12a of the hard bias film 12 in the plane-direction are defined by the specific area or the resist layers 8b (the tunnel junction element 6), so that they are outwardly projected from outer edges of the upper shielding layer.

Next, as shown in FIG. 1D, the resist layer 8 is removed, and another resist layer 13 is newly formed on the read-element 6a and the hard bias film 12, then the tunnel junction element layer 6 except the exposed read-element 6a is removed by etching.

In FIG. 1E, the resist layer 13 is removed, and a separating layer 14 is formed on the read-element 6a and the hard bias film 12.

Successively, the upper shielding layer is formed on the separating layer 14. A process for forming the upper shielding layer will be explained.

Firstly, as shown in FIG. 2F, an electric conductive layer 15 is formed on the separating layer 14. Then, a resist pattern 17 is formed on the electric conductive layer 15 except the area 19, in which the upper shielding layer will be formed.

Note that, as described above, the area 19 is smaller than the specific area, in which the hard bias film is formed, so as to outwardly project the outer edges 12a of the hard bias film 12 in the plane-direction from the outer edges of the upper shielding layer in the same direction. Namely, the resist pattern 17 is formed so as to form the upper shielding layer in the area enclosed by the outer edges 12a of the hard bias film 12.

In FIG. 2G, the upper shielding layer 16 is formed on a part of the electric conductive layer 15, which is exposed from the resist pattern 17, by plating with using the electric conductive layer 15 as an electric power feeding layer. Then, the resist pattern 17 is removed.

In FIG. 2H, parts of the electric conductive layer exposed by removing the resist pattern 17 and parts of the hard bias film 12, which are outwardly projected from the outer edges 16a of the upper shielding layer 16 in the plane-direction, are removed by an etching process, in which the upper shielding layer 16 is used as an etching mask.

Further, as shown in FIG. 2I, an insulating layer 18 is formed on the both sides of the upper shielding layer 16 and the hard bias film 12.

Note that, in FIGS. 2H and 2I, the electric conductive layer 15 formed on the separating layer 14 and the upper shielding layer 16 are shown as one layer 16.

In the production method of the present embodiment, as shown in FIGS. 1C and 1D, the hard bias film 12 is firstly formed, and the outer edges 12a of the hard bias film 12 in the plane-direction are outwardly projected from the outer edges 16a of the upper shielding layer 16 in the plane-direction. Then, as shown in FIGS. 2G and 2H, the upper shielding layer 16, and the projected parts of the hard bias film 12 by the etching process, in which the upper shielding layer 16 is used as the etching mask. Therefore, the outer edges 12b of the hard bias film 12, which has been etched, and the outer edges 16a of the upper shielding layer 16 can be highly precisely coincided.

With above described method, the upper shielding layer 16 can be formed on the flat hard bias film 12 having no step-shaped parts, and no step-shaped parts are formed by displacement of the outer edges 12b of the hard bias film 12 and the outer edges 16a of the upper shielding layer 16. By forming the upper shielding layer 16 highly flat, forming magnetic walls in the upper shielding layer 16, which cause noises, can be prevented.

The outer edges 12b and 16a are mutually coincided; weakening the leakage magnetic field and insufficient magnetic domain control can be prevented even if the upper shielding layer is smaller than the hard bias film.

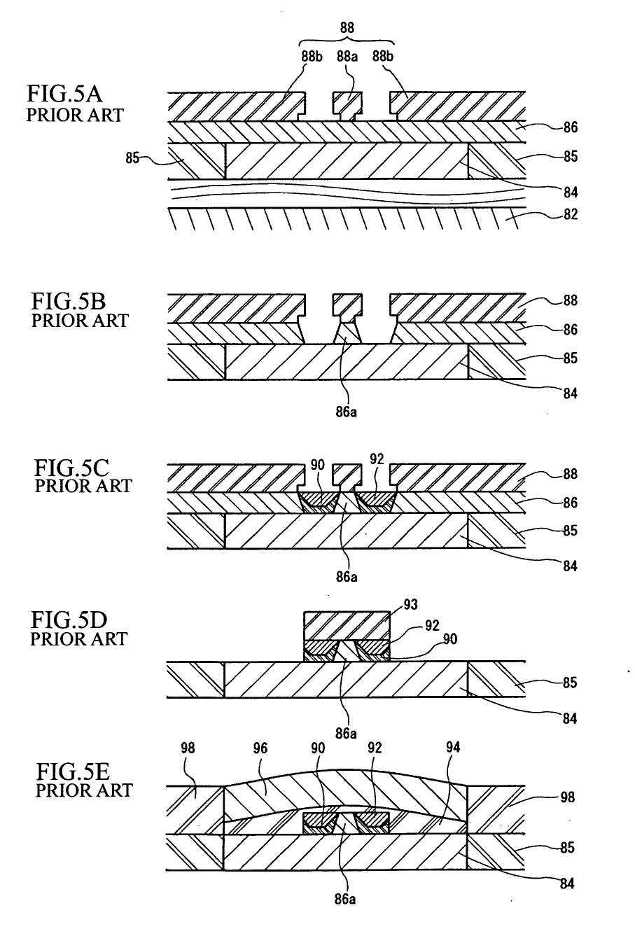

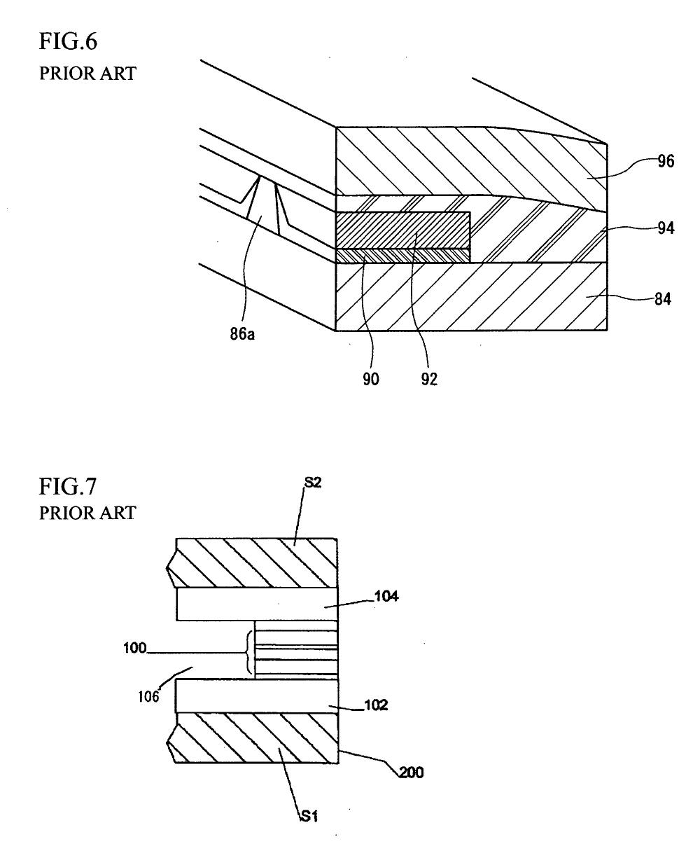

FIG. 1A-1E and FIG. 2F-2I are the partial sectional views seen from the air bearing surface of the thin film magnetic head. Further, the outer edges 12b of the hard bias film 12 and the outer edges 16a of the upper shielding layer 16 in the height-direction may be processed, as shown in FIG. 4, so as to highly precisely set positions of the outer edges in the plane-direction.

Note that, the steps shown in FIG. 2G-2I may be replaced with the steps shown in FIG. 3G-3I.

In FIG. 3G, the upper shielding layer 16 is formed by plating. This state is the same as that shown in FIG. 2G.

In FIG. 3H, parts of the exposed electric conductive layer 15, the hard bias film 12 and the lower shielding layer 4, which are outwardly projected the outer edges 16a of the upper shielding layer 16 in the plane-direction, are removed by the etching process, in which the upper shielding layer 16 is used as the etching mask.

Further, as shown in FIG. 3I, an insulating layer 20 is formed on the outer sides of the upper shielding layer 16, the hard bias film 12 and the lower shielding layer 4. With this step, positions of outer edges 4a of the lower shielding layer 4 can be coincided with the outer edges 12b and 16a of the hard bias film 12 and the upper shielding layer 16.

Note that, in FIGS. 3H and 3I too, the electric conductive layer 15 formed on the separating layer 14 and the upper shielding layer 16 are shown as one layer 16.

With this structure, the thin film magnetic head has the same functions.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method of producing a thin film magnetic head,
comprising the steps of:
forming a read-element on a wafer substrate;
forming a hard bias film on the both sides of the read-element;
forming an upper shielding layer in a specific area, which is located on the read-element and the hard bias film and defined by outer edges of the hard bias film in a plane-direction; and
removing parts of the upper shielding layer, which are outwardly projected from outer edge of the upper shielding layer in the plane-direction, by etching, wherein the upper shielding layer is used as a mask of the etching process.

2. The method according to claim 1,
wherein a separating layer is formed on the read-element and the hard bias film, and
the upper shielding layer is formed on the separating layer.

3. The method according to claim 2,
wherein said step of forming the upper shielding layer comprises the sub-steps of:
forming an electric conductive layer on the separating layer;
forming a resist pattern on the electric conductive layer; and
forming the upper shielding layer on a part of the electric conductive layer, which is exposed from the resist pattern, by plating with using the electric conductive layer as an electric power feeding layer.

4. The method according to claim 1,
further comprising the steps of:
forming a lower shielding layer on the wafer substrate before forming the read-element; and
removing parts of the lower shielding layer, which are outwardly projected from the outer edge of the upper shielding layer in the plane-direction, by etching, wherein the upper shielding layer is used as a mask of the etching process.

5. A thin film magnetic head,
comprising:
a read-element;
a hard bias film being formed on the both sides of the read-element; and
an upper shielding layer being formed on the read-element and the hard bias film, the upper shielding layer having outer edges in the plane-direction, which correspond to those of the hard bias film.

6. The thin film magnetic head according to claim 5,
further comprising a lower shielding layer being located under the read-element, the lower shielding layer having outer edges in the plane-direction, which correspond to those of the upper shielding layer.
